(19) United States
(12) Patent Application Publication
(10) Pub. No.: US 2025/0130695 A1
(43) Pub. Date: Apr. 24, 2025

(54) INTERACTION METHOD AND APPARATUS, ELECTRONIC DEVICE, AND STORAGE MEDIUM

(71) Applicant: Beijing Zitiao Network Technology Co., Ltd., Haidian District, Beijing (CN)

(72) Inventors: Peihui ZHANG, Beijing (CN); Xulei YE, Beijing (CN); Xi LI, Beijing (CN)

(21) Appl. No.: 18/834,197

(22) PCT Filed: Jan. 10, 2023
(86) PCT No.: PCT/CN2023/071574

§ 371 Date: Jul. 29, 2024

(30) Foreign Application Priority Data
Jan. 29, 2022 (CN) 202210113020.4

(51) Int. Cl. G06F 3/0483; G06F 9/451

(52) U.S. Cl. CPC G06F 3/0483; G06F 9/451

(57) ABSTRACT

Embodiments of the present disclosure provide an interaction method and apparatus, an electronic device, a storage medium and a computer program product. The method includes: receiving a first trigger operation acting on a personal homepage of a target user; and in response to the first trigger operation, switching a current page from the personal homepage to an object display page, and displaying an object received by the target user on the object display page.

The application claims priority to the Chinese patent application No. 202210113020.4, filed on Jan. 29, 2022, the entire disclosure of which is incorporated herein by reference as part of the present application.

### TECHNICAL FIELD

Embodiments of the present disclosure relate to a field of computer technology, and particularly, to an interaction method and apparatus, an electronic device, a storage medium and a computer program product.

### BACKGROUND

At present, a user may publish multimedia content such as videos for other users to view, view multimedia content published by other users, and express his/her own attitude towards the multimedia content viewed thereby, for example, like, comment, or forward the multimedia content.

However, in the related technology, the personal homepage interaction mode is relatively monotonous, and cannot meet diverse interaction needs of users, resulting in poor user experience.

### SUMMARY

Embodiments of the present disclosure provide an interaction method and apparatus, an electronic device, a storage medium and a computer program product.

In the first aspect, embodiments of the present disclosure provide an interactive method which comprises:
receiving a first trigger operation acting on a personal homepage of a target user;
switching a current page from the personal homepage to an object display page, and displaying an object received by the target user on the object display page, in response to the first trigger operation.

In the second aspect, embodiments of the present disclosure provide an interaction apparatus which comprises:
a first receiving module, configured to receive a first trigger operation acting on a personal homepage of a target user; and
a first display module, configured to, switch a current page from the personal homepage to an object display page, and display an object received by the target user on the object display page, in response to the first trigger operation.

In the third aspect, embodiments of the present disclosure provide an electronic device which comprises:
one or more processors; and
a memory, configured to store one or more programs;
upon the one or more programs being executed by the one or more processors, the one or more processors implement the interaction method provided by the embodiments of the present disclosure.

In the fourth aspect, embodiments of the present disclosure provide a computer readable storage medium with a computer program stored therein, upon the program being executed by a processor, the interaction method provided by the embodiments of the present disclosure is implemented.

In the fifth aspect, embodiments of the present disclosure provide a computer program product, upon the computer program product being executed by a computer, the interaction method provided by the embodiments of the present disclosure is implemented by the computer.

### BRIEF DESCRIPTION OF THE DRAWINGS

In the drawings throughout, same or similar drawing reference signs represent same or similar elements. It should be understood that the drawings are schematic, and originals and elements may not necessarily be drawn to scale.

FIG. 1 is a schematic flow chart of an interaction method provided by an embodiment of the present disclosure;

FIG. 2 is a schematic diagram of display of a personal homepage provided by an embodiment of the present disclosure;

FIG. 3 is a schematic diagram of an object display page provided by an embodiment of the present disclosure;

FIG. 4 is a schematic flow chart of another interaction method provided by an embodiment of the present disclosure;

FIG. 5 is a schematic diagram of display of another personal homepage provided by an embodiment of the present disclosure;

FIG. 6 is a schematic diagram of display of a first object panel provided by an embodiment of the present disclosure;

FIG. 7 is a schematic diagram of display of another first object panel provided by an embodiment of the present disclosure;

FIG. 8 is a structural block diagram of an interaction apparatus provided by an embodiment of the present disclosure; and

FIG. 9 is a schematic structural diagram of an electronic device provided by an embodiment of the present disclosure.

### DETAILED DESCRIPTION

It should be understood that the multiple steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information interacted between a plurality of apparatuses according to the implementations of the present disclosure are only used for illustrative purposes, and are not used to limit the scope of these messages or information.

FIG. 1 is a schematic flow chart of an interaction method provided by an embodiment of the present disclosure. The method may be executed by an interaction apparatus, wherein, the apparatus may be implemented by software and/or hardware, may be configured in an electronic device, and for example, may be configured in a mobile phone or a tablet personal computer. The interaction method provided by the embodiment of the present disclosure is applicable to a scene where a current user interacts with a target user in a personal homepage of the target user. As shown in FIG. 1, the interaction method provided by this embodiment may include:
S101: receiving a first trigger operation acting on a personal homepage of a target user.

The target user may be a user currently viewing his/her own personal homepage, that is, the user to whom the currently displayed personal homepage belongs; and the personal homepage is the personal homepage of the target user. The first trigger operation may be an operation instructing a terminal device to display an object received by the target user in an object display page of the target user, for example, an operation of triggering a control with a corresponding function in the personal homepage or other trigger operation. Preferably, the first trigger operation is a slide operation of which the slide direction is along a preset direction, so there is no need to set a control with this function in the personal homepage, which may reduce the number of the set controls.

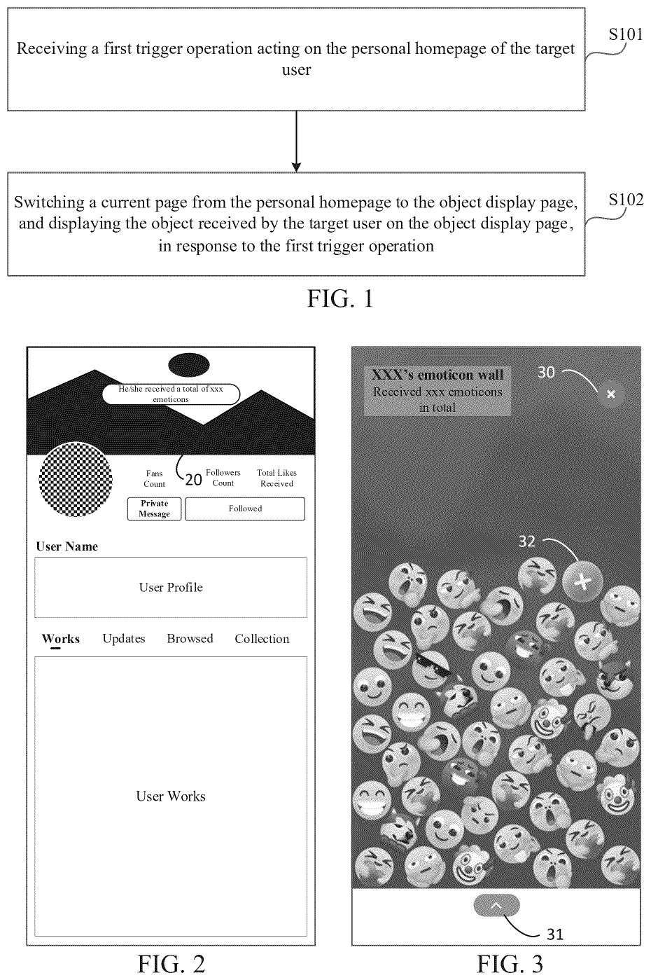

Exemplarily, as shown in FIG. 2, the terminal device displays the personal homepage of the target user, and displays a background image of the personal homepage of the target user in a background image display region 20 of the personal homepage. Therefore, when the current user wants to view the object received by the target user in an object display homepage, he/she can execute the first trigger operation, for example, slide down on the personal homepage and end sliding when sliding to a distance greater than or equal to a first distance threshold.
S102: switching a current page from the personal homepage to the object display page, and displaying the object received by the target user on the object display page, in response to the first trigger operation.

In the step S102, the object display page may be a full screen display page which may be obtained by zooming in an object display region of the personal homepage to full screen. The object received by the target user may be an interaction object sent to the target user by other user except the target user; the specific type of the object may be set as needed, for example, the object may be an emoji image, but it is not limited to this case, and the specific type of the object may also be other objects that can be used for other users (viewing users) to interact with the target user. Correspondingly, other user may interact with the target user, for example, express his/her like for the target user, by sending an emoji image to the target user. Hereinafter, it is illustrated by taking the object as an emoji image.

Exemplarily, the terminal device may judge whether a slide distance of the current user is greater than or equal to the first distance threshold, in response to receiving the first trigger operation, for example, in response to detecting the end of the sliding of the current user, determine the slide operation as the first trigger operation in response to determining that the slide distance of the current user is greater than or equal to the first distance threshold, switch the current page from the personal homepage to the object display page, and display the object received by the target user on the object display page, as shown in FIG. 3.

In addition, the terminal device may further control content displayed in the personal homepage to move down synchronously with the sliding of the current user during the sliding down process of the current user, and restore the content displayed in the personal homepage to an original display position thereof at the end of sliding of the user (for a case where the slide distance of the current user is less than the first distance threshold), or, switch the personal homepage to the object display page (for a case where the slide distance of the current user is greater than or equal to the first distance threshold). When the slide distance of the current user reaches the first distance threshold, corresponding prompt information may be displayed in the background image display region to prompt the user to stop sliding so as to switch to the object display page.

In one implementation, when the object received by the target user is displayed on the object display page, the object received by the target user may be directly displayed in a static manner, that is, the object received by the target user is displayed directly on the object display page without controlling the object to move.

In another implementation, when displaying the object received by the target user, the respective objects may be controlled to move under an action of gravity and/or elasticity until a speed and an acceleration thereof both decrease to zero, to increase fun of displaying the objects. In this case, the displaying the object received by the target user includes: controlling the object received by the target user to move according to a preset control factor in response to preset conditions being met, in which, the preset control factor includes at least one selected from a group consisting of a current tilt angle of the terminal device, gravity, and a preset elasticity coefficient of the object.

The terminal device may be a device that displays the object, for example, a computer device that executes the interaction method provided by this embodiment. The current tilt angle of the terminal device may be a tilt angle of the terminal device relative to a horizontal plane at the current moment, and may be detected by a gyroscope configured in the terminal device.

For example, the object received by the target user may be displayed at a set boundary of the object display page (e.g., an upper boundary of the object display page); then, the object may be controlled to move according to the current tilt angle of the terminal device, the gravity of the terminal device, and/or the preset elasticity coefficient of the object, until a speed and an acceleration of the object both decrease to zero.

In addition, when displaying the object received by the target user at the set boundary, an object control for instructing the terminal device to display a first object panel/second object panel may be displayed at the set boundary, and the object control is controlled to move according to the current tilt angle of the terminal device, the gravity of the terminal device, and/or the preset elasticity coefficient of the object control until a speed and an acceleration thereof both decrease to zero.

In the process of controlling the object control and the object to move according to the current tilt angle of the terminal device, the gravity of the terminal device and/or the preset elasticity coefficient of the object control and the object, when the object control/object does not collide with other body (e.g., other object or the boundary of the object display page), a gravity component of the gravity within the display plane of the terminal device may be determined according to the tilt angle of the terminal device at the current moment, and the object control/object is controlled to move within the preset display region according to the gravity component; when the object control/object collides with other body, an elastic force acting on the object control/object may be determined according to a speed thereof at the current movement and the preset elasticity coefficient, and the object control/object is controlled according to the elastic force and the gravity.

Here, when displaying the object control and the object, initial speeds of the object control and the object may be set to zero or other speed value, for example, may be set to a speed value greater than zero, to ensure that the object control and the object can still move in the preset display region when the display plane of the terminal device is parallel to the horizontal plane. In the case where the set boundary is the upper boundary, a direction of the initial speed may be a downward direction perpendicular to the upper boundary.

In addition, in the process of controlling the object control/object to move, when the tilt angle of the terminal device changes, the gravity component of the gravity within the display plane of the terminal device may be calculated in real-time according to the changed tilt angle, and the object control/object may be controlled according to the gravity component. After the speed and the acceleration of the object control/object both decrease to zero, when the tilt angle of the terminal device changes, for example, when the user shakes the mobile phone, then the object control/object displayed in the preset display region may be controlled to shake and collide in the preset display region with shaking of the user, and the mobile phone may be controlled to vibrate.

The interaction method provided by this embodiment involves: receiving the first trigger operation acting on the personal homepage of the target user; switching the current page from the personal homepage to the object display page, and displaying the object received by the target user on the object display page, in response to the first trigger operation. In this embodiment, by adopting the above-described technical solution, the object sent by other user to the target user is displayed on the object display page, based on the first trigger operation of the current user in the personal homepage of the target user, which can not only enrich the personal homepage interaction mode, but also show more comprehensive information, allowing the current user to view the object sent by other user to the target user, so as to provide a brand new scene for the current user to view and interact with the target user, increase interaction atmosphere between the current user and the target user, and improve interaction experience between the current user and the target user.

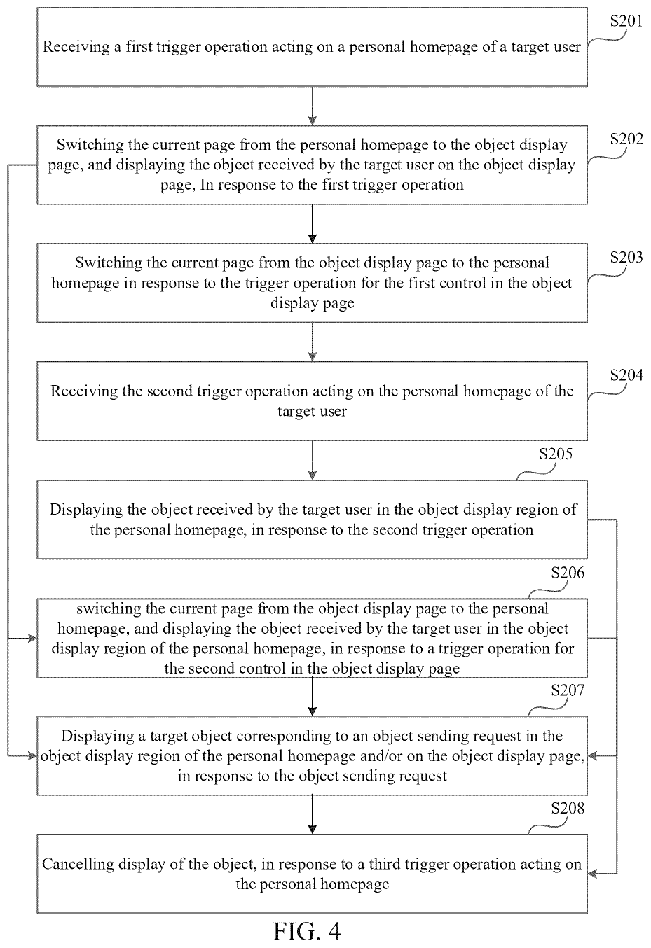

FIG. 4 is a schematic flow chart of another interaction method provided by an embodiment of the present disclosure. The solution according to this embodiment may be combined with one or more example solutions in the above-described embodiments. For example, the interaction method provided by this embodiment further includes: receiving a second trigger operation acting on the personal homepage of the target user; and displaying the object received by the target user in the object display region of the personal homepage, in response to the second trigger operation.

For example, after the displaying the object received by the target user on the object display page, the method further includes: switching the current page from the object display page to the personal homepage in response to a trigger operation for a first control in the object display page.

For example, after the displaying the object received by the target user on the object display page, the method further includes: in response to a trigger operation for a second control in the object display page, switching the current page from the object display page to the personal homepage, and displaying the object received by the target user on the object display region of the personal homepage.

For example, after the displaying the object received by the target user on the object display region of the personal homepage, the method further includes: canceling the display of the object, in response to a third trigger operation acting in the personal homepage.

For example, the interaction method provided by this embodiment further includes: displaying a target object corresponding to an object sending request in the object display region of the personal homepage and/or on the object display page, in response to the object sending request.

Correspondingly, as shown in FIG. 4, the interaction method provided by this embodiment may include:
S201: receiving a first trigger operation acting on a personal homepage of a target user;
S202: switching the current page from the personal homepage to the object display page, and displaying the object received by the target user on the object display page, in response to the first trigger operation; and executing S203, S206 or S207.
S203: switching the current page from the object display page to the personal homepage in response to the trigger operation for the first control in the object display page.

The first control may be a control instructing the terminal device to stop displaying the object received by the target user, for example, a close control displayed on the object display page.

For example, as shown in FIG. 3, while displaying the object received by the target user on the object display page, the terminal device displays a first control 30 on the object display page. Therefore, when the current user finishes viewing and wants to instruct the terminal device to stop displaying the object received by the target user, he/she may trigger the first control 30. Correspondingly, in response to detecting the first control 30 displayed on the object display page triggered by the current user, the terminal device may display the personal homepage of the target user and not continue to display the object received by the target user on the personal homepage, for example, display the background image in the background image display region 20 of the personal homepage, without displaying the object received by the target user in the background image display region 20, as shown in FIG. 2.
S204: receiving the second trigger operation acting on the personal homepage of the target user.
S205: displaying the object received by the target user in the object display region of the personal homepage, in response to the second trigger operation, and executing S207 or S208.

The second trigger operation may be a trigger operation instructing the terminal device to display the object received by the target user in the personal homepage of the target user in the case where the terminal device currently does not display the object received by the target user, for example, an operation of triggering a control with a corresponding function in the personal homepage or other trigger operation. For example, the first trigger operation may be a slide operation along a preset direction, for example, a slide operation with a slide distance greater than or equal to a second distance threshold and less than the first distance threshold along a preset direction, so that the object received by the target user may be displayed without setting the control with this function in the personal homepage, which may reduce the number of the set controls. In this case, for example, the first trigger operation and the second trigger operation have a same slide direction; the slide distance of the first trigger operation is greater than or equal to the first distance threshold and less than the second distance threshold, and the slide distance of the second trigger operation is greater than or equal to the second distance threshold. Here, the first distance threshold and the second distance threshold may be set according to needs, which will not be limited in this embodiment; the preset direction may be flexibly set according to needs, for example, the preset direction may be upward, downward, leftward or rightward, etc. The object display region may be a region in the personal homepage that is used for displaying the object received by the target user, which may be located in the background image display region in the personal homepage of the target user or other region; the background image display region may be used for displaying the background image of the personal homepage of the target user; and the personal page background image region in related technology is usually used for exhibiting an image set by the target user or an image configured by a display system (also referred to as an initial background image). The background image region according to the present disclosure may not only display the initial background image, but also display the image of the object received by the target user (which may be directly exhibited on the initial background image in a superimposed manner, or may also be exhibited by replacing the initial background image), in response to an interaction operation of the user. In addition, the background image region may also be extended to full screen exhibition in response to an interaction operation of the user to meet interaction needs of the user. Therefore, it can enrich the interaction mode of the personal homepage background image, meet diverse needs of users, and improve user experience.

Hereinafter, it is illustrated by taking the preset direction as a downward direction, and the object display region as the background image display region in the personal homepage.

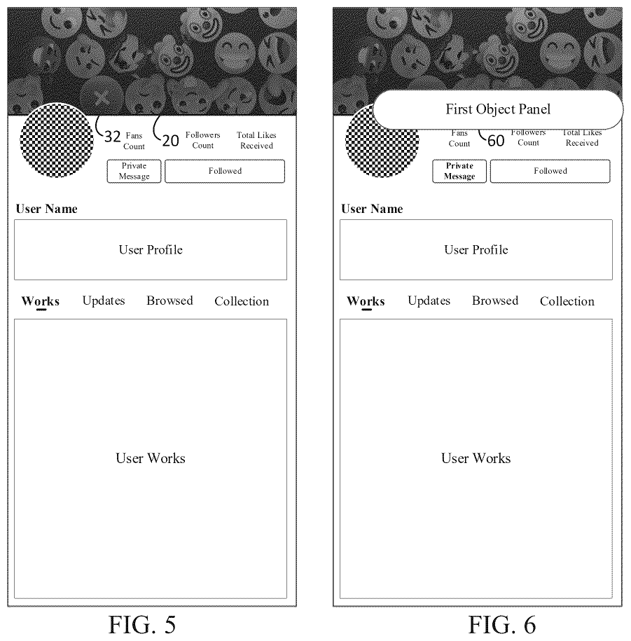

Exemplarily, as shown in FIG. 2, the terminal device displays the personal homepage of the target user, displays the background image in the background image display region 20 of the personal homepage, and may display the total number of objects received by the target user in an upper layer of the background image. Therefore, when the current user wants to view the objects received by the target user in the personal homepage, he/she may slide down in the personal homepage and end sliding when he/she slides to a certain distance between the second distance threshold and the first distance threshold. Correspondingly, in response to detecting the end of sliding of the current user, the terminal device judges whether the slide distance of the current user is greater than or equal to the second distance threshold and less than the first distance threshold, and switches the background image displayed in the background image display region 20 to the objects received by the target user in response to determining that the slide distance of the current user is greater than or equal to the second distance threshold and less than the first distance threshold, as shown in FIG. 5. Correspondingly, the terminal device may continue to display the background image in the background image display region 20, in response to determining that the slide distance of the current user is less than the second distance threshold.

In addition, in the sliding process of the current user, when the slide distance of the current user reaches the second distance threshold and is less than the first distance threshold, the terminal device may display corresponding prompt information in the background image display region to prompt the user to stop sliding so as to view the objects received by the target user in the personal homepage.

In this embodiment, when the user slides down different distances, the objects received by the target user may be displayed on different pages. Therefore, different viewing needs of the user may be met just through simple slide operations without configuring an additional control in the personal homepage. This may reduce changes to the layout of the personal homepage and simplify operations that the user needs to execute, on the premise of meeting viewing needs of the user.

It should be noted that the first trigger operation and the second trigger operation may also have different slide directions in the case where both are slide operations; for example, the first trigger operation may be a slide operation with a slide direction of a first preset direction and a slide distance greater than or equal to the first preset distance threshold; and the second trigger operation may be a slide operation with a slide direction of a second preset direction and a slide distance greater than or equal to the second preset distance threshold. In this case, the first preset direction and the second preset direction may be different; and the first preset distance threshold and the second preset distance threshold may be the same or different.
S206: in response to a trigger operation for the second control, switching the current page from the object display page to the personal homepage in the object display page, and displaying the object received by the target user in the object display region of the personal homepage, and executing S207 or S208.

The second control may be a control instructing the terminal device to stop displaying the object received by the target user on the object display page, for example, a return control displayed on the object display page.

For example, as shown in FIG. 3, the terminal device displays a second control 31 on the object display page, while displaying the object received by the target user on the object display page. Thus, when the current user wants to instruct the terminal device to stop displaying the object received by the target user on the object display page, he/she may trigger the second control 31. Correspondingly, in response to detecting the second control 31 displayed on the object display page triggered by the current user, the terminal device may display the personal homepage of the target user and display the object received by the target user in the object display region of the personal homepage, as shown in FIG. 5, for example, zoom out the object display page to the background image display region 20 of the personal homepage, and display the object received by the target user in the background image display region 20.

It may be understood that this embodiment is not limited to switching the currently displayed object display page to the personal homepage by triggering the first control/second control. For example, the currently displayed object display page may also be switched to the personal homepage, in response to a preset trigger operation, for example, a preset trigger gesture, is received.
S207: displaying a target object corresponding to an object sending request in the object display region of the personal homepage and/or on the object display page, in response to the object sending request.

The object sending request may be a request to send a certain object to the target user. Correspondingly, the target object may be an object to be sent as requested in the object sending request, for example, an emoji image to be sent as requested in the object sending request, which may be sent by the current user on the personal homepage of the target user or on the object display page through the object sending request.

For example, when the current user wants to send a certain object to the target user, he/she may instruct the terminal device to generate an object sending request through a corresponding trigger operation (e.g., triggering an object identifier of the object). Correspondingly, in response to detecting a trigger operation of the current user requesting to send a certain object, the terminal device may generate an object sending request, and display a target object to be sent as requested in the object sending request in the object display region of the personal homepage and/or on the object display page, in response to the object sending request; or may also display the target object to be sent as requested in the object sending request in the object display region of the personal homepage in response to the current page being a personal homepage; or may also display the target object to be sent as requested in the object sending request on the object display page in response to the current page being an object display page.

In this embodiment, the current user may not only view the object received by the target user, but also send a corresponding object to the target user; for example, the current user may not only view an emoji image sent by other user to the target user, but also send an emoji image to the target user, so as to provide a brand new scene for the current user to view and interact with the target user, increase interaction atmosphere between the current user and the target user (especially between a fan and a publisher of multimedia content), and improve interaction experience between the current user and the target user.

In one implementation, before the displaying a target object corresponding to an object sending request in the object display region of the personal homepage and/or on the object display page, in response to the object sending request, the method further includes: displaying a first object panel, in response to a trigger operation for the object control displayed in the object display region of the personal homepage and/or on the object display page, in which a plurality of different object identifiers are displayed on the first object panel; and the displaying a target object corresponding to an object sending request in the object display region of the personal homepage and/or on the object display page, in response to the object sending request, includes: displaying a target object corresponding to a target object identifier in the object display region of the personal homepage and/or on the object display page, in response to a first object sending request for the target object identifier among the plurality of different object identifiers.

The first object panel may be understood as an object identifier display panel used for displaying a plurality of different object identifiers. The first object sending request may be an object sending request generated in response to trigger of a certain object displayed on the first object panel. Correspondingly, the target object identifier may be an object identifier triggered by the current user. The object identifier is used to trigger the sending of the object corresponding to the object identifier. For example, the object identifier may be an interactive image or text identifier corresponding to the object, such as a thumbnail icon. In the case where the object is an emoji, the object identifier is an emoji identifier, such as an interactive emoji icon.

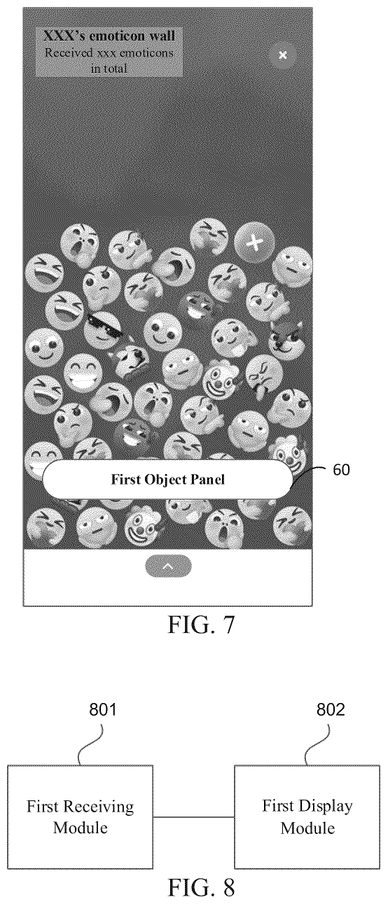

For example, as shown in FIG. 3 and FIG. 5, the terminal device displays the respective objects received by the target user and the object control 32 on the object display page or in the object display region of the personal homepage. When the current user wants to send an object to the target user, he/she may trigger the object control 32. In response to detecting the current user triggering the object control 32, the terminal device may display a first object panel 60, as shown in FIG. 6 and FIG. 7, and display a plurality of different object identifiers (not shown in the diagram) in the first object panel 60. Therefore, when the current user wants to send a certain object to the target user, he/she may trigger the object identifier of the object displayed on the first object panel 60. Correspondingly, in response to detecting the current user triggering a certain object identifier displayed on the first object panel 60, the terminal device may generate a first object sending request, and display the object corresponding to the object identifier on the object display page or in the object display region of the personal homepage in response to the first object sending request, for example, display the object corresponding to the object identifier on the object display page or in the object display region of the personal homepage in an adding manner.

Exemplarily, assuming that the current user is user A and the target user is user B, when user A views a personal homepage or an object display page of user B, the terminal device may display a plurality of emoji images received by user B in the object display region of the personal homepage or on the object display page. When user A wants to send an emoji to user B, he/she may trigger a corresponding emoji identifier in a first emoji panel. Thus, in response to detecting user A triggering a certain emoji identifier in the first emoji panel, the terminal device may send an emoji image corresponding to the emoji identifier to the target user, and display the emoji image in the object display region of the personal homepage or on object display page in an adding manner.

In another implementation, before the displaying a target object corresponding to an object sending request in the object display region of the personal homepage and/or on the object display page, in response to the object sending request, the method further includes: displaying a second object panel, in response to a trigger operation for the object control displayed in the object display region of the personal homepage and/or on the object display page, in which a plurality of identical object identifiers are displayed in the second object panel; and the displaying a target object corresponding to an object sending request in the object display region of the personal homepage and/or on the object display page, in response to the object sending request, includes: determining a target object corresponding to a target object identifier based on a random algorithm in response to a second object sending request for a target object type identifier among the plurality of identical object identifiers, and displaying the target object in the object display region of the personal homepage and/or on the object display page. Thus, the interaction mode is enriched, and user experience is improved.

The second object panel may be understood as an object identifier display panel used for displaying a plurality of identical object identifiers. The second object sending request may be an object sending request generated in response to trigger of a certain object identifier displayed in the second object panel. Correspondingly, the target object identifier may be an object identifier triggered by the current user.

For example, as shown in FIG. 3 and FIG. 5, the terminal device displays the respective objects received by the target user and the object control 32 on the object display page or in the object display region of the personal homepage. When the current user wants to send an object to the target user, he/she may trigger the object control 32. In response to detecting the current user triggering the object control 32, the terminal device may display a second object panel, and display a plurality of identical object identifiers in the second object panel. Therefore, when the current user wants to send an object to the target user, he/she may trigger a certain object identifier displayed in the second object panel. Correspondingly, in response to detecting the current user triggering a certain object identifier displayed in the second object panel, the terminal device may generate a second object sending request, randomly select an object as the target object in response to the second object sending request, and display the target object on the object display page or in the object display region of the personal homepage, for example, display the target object on the object display page or in the object display region of the personal homepage in an adding manner.

In addition, after the target object is sent to the target user, display of the first object panel/the second object panel may be further stopped, and/or an object notification may be sent to the target user through a server to notify the target user that the current user has sent the target object thereto.

When the object display region of the personal homepage and/or the object display page displays a certain object (including the target object), when the object collides with other object, or when the object moves to the boundary of the object display region of the personal homepage and/or the boundary of the object display page, a collision animation effect may be played to prompt the current user; in this case, the interaction method provided by this embodiment further includes: playing a collision animation effect, in the case where a plurality of objects collide or at least one object moves to the boundary of the object display region of the personal homepage and/or the boundary of the object display page.
S208: cancelling the display of the object, in response to a third trigger operation acting on the personal homepage.

In this embodiment, the third trigger operation may be an operation used for instructing the terminal device to cancel display of the object received by the target user, in the case where the terminal device already displays the object received by the target user in the object display region of the personal homepage, which may be an operation the same as or different from the second trigger operation. In the case where the third trigger operation is an operation the same as the second trigger operation, the second trigger operation may be not only used for instructing the terminal device to display the object received by the target user in the personal homepage of the target user in the case where the terminal device currently does not display the object received by the target user, but also instructing the terminal device to cancel the display of the object received by the target user in the case where the terminal device currently already displays the object received by the target user, that is, in the case where the object received by the target user is not displayed on the personal homepage, the terminal device may display the object received by the target user on the personal homepage in response to receiving the second trigger operation; and in the case where the object received by the target user is already displayed on the personal homepage, the terminal device may stop displaying the object received by the target user on the personal homepage in response to receiving the second trigger operation.

For example, as shown in FIG. 5, the terminal device displays the object received by the target user in the object display region of the personal homepage of the target user. Therefore, when the current user wants to instruct the terminal device to stop display of the object received by the target user, he/she may execute the third trigger operation, for example, slide down a certain distance between the second distance threshold and the first distance threshold. Correspondingly, in response to detecting the user executing the third trigger operation, the terminal device may stop displaying the object received by the target user, for example, may switch the object received by the target user displayed in the object display region to the background image of the personal homepage, as shown in FIG. 2.

By using the interaction method provided by this embodiment, the object received by the target user may be displayed on different pages based on different trigger operations of the user, or, the display of the object received by the target user may be stopped, to meet different viewing needs of the user and further improve user experience.

FIG. 8 is a structural block diagram of an interaction apparatus provided by an embodiment of the present disclosure. The apparatus may be implemented by software and/or hardware, and may be configured in an electronic device, for example, may be configured in a mobile phone or a tablet personal computer, and may implement interaction between different users by executing the interaction method. As shown in FIG. 8, the interaction apparatus provided by this embodiment may include: a first receiving module 801 and a first display module 802, in which
the first receiving module 801 is configured to receive a first trigger operation acting on a personal homepage of a target user;
the first display module 802 is configured to, switch the current page from the personal homepage to the object display page, and display the object received by the target user on the object display page, in response to the first trigger operation.

The interaction apparatus provided by this embodiment receives the first trigger operation acting on the personal homepage of the target user by the first receiving module, switches the current page from the personal homepage to the object display page by the first display module and displays the object received by the target user on the object display page, in response to the first trigger operation. In this embodiment, by adopting the above-described technical solution, the object sent by other user to the target user is displayed on the object display page, based on the first trigger operation by the current user in the personal homepage of the target user, which can not only enrich the personal homepage interaction mode, but also show more comprehensive information, allowing the current user to view the object sent by other user to the target user, so as to provide a brand new scene for the current user to view and interact with the target user, increase interaction atmosphere between the current user and the target user, and improve interaction experience between the current user and the target user.

For example, the interaction apparatus provided by this embodiment may further include: a second receiving module, configured to receive a second trigger operation acting on the personal homepage of the target user; and a second display module, configured to display the object received by the target user in the object display region of the personal homepage, in response to the second trigger operation.

In the above-described solution, the first trigger operation and the second trigger operation may be slide operations; the first trigger operation and the second trigger operation may have a same slide direction; a slide distance of the first trigger operation may be greater than or equal to a first distance threshold; and a slide distance of the second trigger operation may be greater than or equal to a second distance threshold and less than the first distance threshold.

For example, the interaction apparatus provided by this embodiment may further include: a first page switching module, configured to switch the current page from the object display page to the personal homepage in response to a trigger operation for a first control on the object display page, after displaying the object received by the target user on the object display page.

For example, the interaction apparatus provided by this embodiment may further include: a second page switching module, configured to, after displaying the object received by the target user on the object display page, switch the current page from the object display page to the personal homepage, and display the object received by the target user in the object display region of the personal homepage, in response to a trigger operation for a second control on the object display page.

For example, the interaction apparatus provided by this embodiment may further include: a display cancelling module, configured to cancel the display of the object, in response to a third trigger operation acting on the personal homepage, after displaying the object received by the target user in the object display region of the personal homepage.

For example, the interaction apparatus provided by this embodiment may further include: a target object display module, configured to display a target object corresponding to an object sending request in the object display region of the personal homepage and/or on the object display page, in response to the object sending request.

For example, the interaction apparatus provided by this embodiment may further include: a first panel display module, configured to display a first object panel in response to a trigger operation for an object control displayed in the object display region of the personal homepage and/or on the object display page, before the displaying a target object corresponding to an object sending request in the object display region of the personal homepage and/or on the object display page in response to the object sending request, in which a plurality of different object identifiers are displayed on the first object panel; and the target object display module may be configured to: in response to a first object sending request for a target object identifier among the plurality of different object identifiers, display a target object corresponding to the target object identifier in the object display region of the personal homepage and/or on the object display page.

For example, the interaction apparatus provided by this embodiment may further include: a first panel display module, configured to display a second object panel in response to a trigger operation for the object control displayed in the object display region of the personal homepage and/or on the object display page, before the displaying a target object corresponding to an object sending request in the object display region of the personal homepage and/or on the object display page in response to the object sending request, in which a plurality of identical object identifiers are displayed in the second object panel; and the target object display module may be configured to: in response to a second object sending request for a target object type identifier among the plurality of identical object identifiers, determine a target object corresponding to the target object identifier based on a random algorithm, and display the target object in the object display region of the personal homepage and/or on the object display page.

In the above-described solution, the displaying the object received by the target user, may include: controlling the object received by the target user to move according to a preset control factor in response to preset conditions being met, in which the preset control factor includes at least one selected from a group consisting of a current tilt angle of the terminal device, gravity of the terminal device, and a preset elasticity coefficient of the object.

For example, the interaction apparatus provided by this embodiment may further include: an animation effect playing module, configured to play a collision animation effect, in the case where a plurality of objects collide or at least one object moves to a boundary of the object display region of the personal homepage and/or a boundary of the object display page.

The interaction apparatus provided by the embodiment of the present disclosure may execute the interaction method provided by any embodiment of the present disclosure, and has the corresponding functional modules and advantageous effects of executing the interaction method. For the technical details not fully described in this embodiment, the interaction method provided by any embodiment of the present disclosure may be referred to.

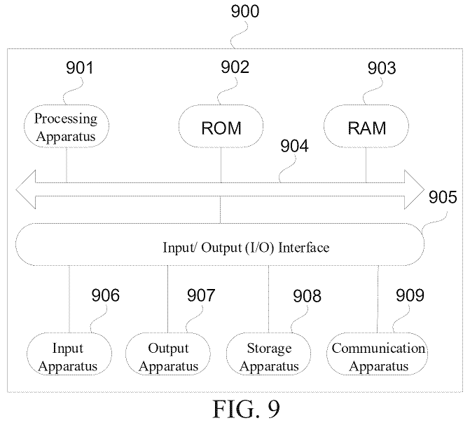

Hereinafter, referring to FIG. 9, it shows a structural schematic diagram of an electronic device (e.g., a terminal device) 900 suitable for implementing the embodiment of the present disclosure. The electronic device according to the embodiment of the present disclosure may include but not limited to a mobile terminal such as a mobile phone, a laptop, a digital broadcast receiver, a personal digital assistant (PDA), a portable android device (PAD), a portable multimedia player (PMP), a vehicle-mounted terminal (e.g., a vehicle-mounted navigation terminal), etc., and a stationary terminal such as a digital TV, a desktop computer, etc. The electronic device shown in FIG. 9 is only an example and should not impose any limitation on functionality and scope of use of the embodiment of the present disclosure.

As shown in FIG. 9, the electronic device 900 may include a processing apparatus (e.g., a central processor, a graphics processor, etc.) 901, which may executes various appropriate actions and processing according to a program stored in a read-only memory (ROM) 902 or a program loaded from a storage apparatus 908 into a random access memory (RAM) 903. Various programs and data required for operation of the electronic device 900 are further stored in the RAM 903. The processing apparatus 901, the ROM 902, and the RAM 903 are connected with each other through a bus 904. An input/output (I/O) interface 905 is also coupled to the bus 904.

Usually, apparatuses below may be coupled to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a speaker, a vibrator, or the like; a storage apparatus 908 including, for example, a magnetic tape, a hard disk, or the like; and a communication apparatus 909. The communication apparatus 909 may allow the electronic device 900 to perform wireless or wired communication with other device so as to exchange data. Although FIG. 9 shows the electronic device 900 including various apparatuses, it should be understood that not all of the illustrated apparatuses are necessarily implemented or included. More or fewer apparatuses may be implemented or included alternatively.

According to the embodiments of the present disclosure, the process described above with reference to a flow chart may be implemented as computer software programs. For example, the embodiments of the present disclosure include a computer program product, including a computer program carried on a non-transitory computer-readable medium, the computer program including program codes for executing the method shown in the flow chart. In such embodiments, the computer program may be downloaded and installed from the network via the communication apparatus 909, or may be installed from the storage apparatus 908, or may be installed from the ROM 902. Upon the computer program being executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-described computer readable medium carries one or more programs; and when executed by the electronic device, the above-described one or more programs cause the electronic device to execute steps of: receiving a first trigger operation acting on a personal homepage of a target user; and switching a current page from the personal homepage to an object display page, and displaying an object received by the target user on the object display page, in response to the first trigger operation.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the module does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides an interaction method, including:
receiving the first trigger operation acting on the personal homepage of the target user; and
switching the current page from the personal homepage to the object display page, and displaying the object received by the target user on the object display page, in response to the first trigger operation.

According to one or more embodiments of the present disclosure, Example 2 provides the method according to Example 1, further includes:
receiving the second trigger operation acting on the personal homepage of the target user; and
displaying the object received by the target user in the object display region of the personal homepage, in response to the second trigger operation.

According to one or more embodiments of the present disclosure, Example 3 provides the method according to Example 2, in which the first trigger operation and the second trigger operation are slide operations, the first trigger operation and the second trigger operation have a same slide direction, the slide distance of the first trigger operation is greater than or equal to the first distance threshold, and the slide distance of the second trigger operation is greater than or equal to the second distance threshold and less than the first distance threshold.

According to one or more embodiments of the present disclosure, Example 4 provides the method according to Example 2, in which after the displaying the object received by the target user on the object display page, the method further includes:
switching the current page from the object display page to the personal homepage in response to the trigger operation for the first control in the object display page.

According to one or more embodiments of the present disclosure, Example 5 provides the method according to Example 2, in which after the displaying the object received by the target user on the object display page, the method further includes:
in response to the trigger operation for the second control in the object display page, switching the current page from the object display page to the personal homepage, and displaying the object received by the target user in the object display region of the personal homepage.

According to one or more embodiments of the present disclosure, Example 6 provides the method according to any one of Examples 2 to 5, in which after the displaying the object received by the target user in the object display region of the personal homepage, the method further includes:
cancelling the display of the object, in response to the third trigger operation acting on the personal homepage.

According to one or more embodiments of the present disclosure, Example 7 provides the method according to any one of Examples 2 to 5, further including:
displaying the target object corresponding to the object sending request in the object display region of the personal homepage and/or on the object display page, in response to the object sending request.

According to one or more embodiments of the present disclosure, Example 8 provides the method according to Example 7, in which before the displaying the target object corresponding to the object sending request in the object display region of the personal homepage and/or on the object display page, in response to the object sending request, the method further includes:
displaying the first object panel, in response to the trigger operation for the object control displayed in the object display region of the personal homepage and/or on the object display page, in which a plurality of different object identifiers are displayed on the first object panel;

The displaying the target object corresponding to the object sending request in the object display region of the personal homepage and/or on the object display page, in response to the object sending request, includes:
in response to the first object sending request for a target object identifier among the plurality of different object identifiers, displaying the target object corresponding to the target object identifier in the object display region of the personal homepage and/or on the object display page.

According to one or more embodiments of the present disclosure, Example 9 provides the method according to Example 7, in which before the displaying the target object corresponding to the object sending request in the object display region of the personal homepage and/or on the object display page, the method further includes:
displaying the second object panel, in response to the trigger operation for the object control displayed in the object display region of the personal homepage and/or on the object display page, in which a plurality of identical object identifiers are displayed in the second object panel;
the displaying the target object corresponding to the object sending request in the object display region of the personal homepage and/or on the object display page, in response to the object sending request, includes:
in response to the second object sending request for a target object type identifier among the plurality of identical object identifiers, determining the target object corresponding to the target object identifier based on a random algorithm and displaying the target object in the object display region of the personal homepage and/or on the object display page.

According to one or more embodiments of the present disclosure, Example 10 provides the method according to any one of Examples 2 to 5, in which the displaying the object received by the target user, includes:
controlling the object received by the target user to move according to the preset control factor in response to preset conditions being met, in which the preset control factor includes at least one selected from a group consisting of a current tilt angle of the terminal device, gravity of the terminal device, and a preset elasticity coefficient of the object.

According to one or more embodiments of the present disclosure, Example 11 provides the method according to Example 10 which further includes:
playing a collision animation effect, in the case where a plurality of objects collide or at least one object moves to the boundary of the object display region of the personal homepage and/or the boundary of the object display page.

According to one or more embodiments of the present disclosure, Example 11 provides an interaction apparatus which includes:
a first receiving module, configured to receive the first trigger operation acting on the personal homepage of the target user; and
a first display module, configured to, switch the current page from the personal homepage to the object display page, and display the object received by the target user on the object display page, in response to the first trigger operation.

According to one or more embodiments of the present disclosure, Example 13 provides an electronic device which includes:
one or more processors;
a memory, configured to store one or more programs,
upon the one or more programs being executed by the one or more processors, the one or more processors implement the interaction method as described in any one of Examples 1 to 11.

According to one or more embodiments of the present disclosure, Example 14 provides a computer readable storage medium with a computer program stored therein, upon the program being executed by a processor, the interaction method as described in any one of Examples 1 to 11 is implemented.

According to one or more embodiments of the present disclosure, Example 15 provides a computer program product, upon the computer program product being executed by a computer, the interaction method as described in any one of Examples 1 to 11 is implemented by the computer.

In addition, while a plurality of operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, a plurality of features described in the context of a single embodiment may also be implemented separately or in any appropriate sub-combination in a plurality of embodiments.

What is claimed is:

1. An interaction method, comprising:
receiving a first trigger operation acting on a personal homepage of a target user;
switching a current page from the personal homepage to an object display page and displaying an object received by the target user on the object display page, in response to the first trigger operation.

2. The method according to claim 1, further comprising:
receiving a second trigger operation acting on the personal homepage of the target user;
displaying the object received by the target user in an object display region of the personal homepage, in response to the second trigger operation.

3. The method according to claim 2, wherein the first trigger operation and the second trigger operation are slide operations, the first trigger operation and the second trigger operation have a same slide direction, a slide distance of the first trigger operation is greater than or equal to a first distance threshold, and a slide distance of the second trigger operation is greater than or equal to a second distance threshold and less than the first distance threshold.

4. The method according to claim 2, wherein after the displaying the object received by the target user on the object display page, the method further comprises:
switching the current page from the object display page to the personal homepage, in response to a trigger operation for a first control on the object display page.

5. The method according to claim 2, wherein after the displaying the object received by the target user on the object display page, the method further comprises:
switching the current page from the object display page to the personal homepage and displaying the object received by the target user in the object display region of the personal homepage, in response to a trigger operation for a second control on the object display page.

6. The method according to claim 2, wherein after the displaying the object received by the target user in the object display region of the personal homepage, the method further comprises:
cancelling the display of the object, in response to a third trigger operation acting on the personal homepage.

7. The method according to claim 2, further comprising:
displaying a target object corresponding to an object sending request in at least one of the object display region of the personal homepage and the object display page, in response to the object sending request.

8. The method according to claim 7, wherein before displaying the target object corresponding to the object sending request in at least one of the object display region of the personal homepage and the object display page, in response to the object sending request, the method further comprises:
displaying a first object panel, in response to a trigger operation for an object control displayed in the object display region of the personal homepage and/or on the object display page, wherein a plurality of different object identifiers are displayed on the first object panel;
wherein displaying the target object corresponding to the object sending request in at least one of the object display region of the personal homepage and the object display page, in response to the object sending request, comprises:
displaying the target object corresponding to a target object identifier in at least one of the object display region of the personal homepage and the object display page, in response to a first object sending request for the target object identifier among the plurality of different object identifiers.

9. The method according to claim 7, wherein before displaying the target object corresponding to the object sending request in at least one of the object display region of the personal homepage and the object display page, in response to the object sending request, the method further comprises:
displaying a second object panel, in response to a trigger operation for an object control displayed in the object display region of the personal homepage and/or on the object display page, wherein a plurality of identical object identifiers are displayed in the second object panel;
wherein the displaying a target object corresponding to an object sending request in the object display region of the personal homepage and/or on the object display page, in response to the object sending request, comprises:
determining the target object corresponding to a target object identifier based on a random algorithm and displaying the target object in at least one of the object display region of the personal homepage and the object display page, in response to a second object sending request for the target object identifier among the plurality of identical object identifiers.

10. The method according to claim 2, wherein the displaying the object received by the target user, comprises:
controlling the object received by the target user to move according to a preset control factor in response to preset conditions being met, wherein the preset control factor comprises at least one selected from a group consisting of a current tilt angle of a terminal device, gravity of the terminal device, and a preset elasticity coefficient of the object.

11. The method according to claim 10, further comprising:
playing a collision animation effect, in response to a plurality of objects colliding or at least one object moving to at least one of a boundary of the object display region of the personal homepage and a boundary of the object display page.

12. (canceled)

13. An electronic device, comprising:
one or more processors;
a memory, configured to store one or more programs,
wherein upon the one or more programs being executed by the one or more processors, the one or more processors implement an interaction method;
the interaction method comprises:
receiving a first trigger operation acting on a personal homepage of a target user;
switching a current page from the personal homepage to an object display page and displaying an object received by the target user on the object display page, in response to the first trigger operation.

14. A computer readable storage medium, with a computer program stored therein, wherein upon the program being executed by a processor, an interaction method is implemented;
the interaction method comprises:
receiving a first trigger operation acting on a personal homepage of a target user;
switching a current page from the personal homepage to an object display page and displaying an object received by the target user on the object display page, in response to the first trigger operation.

15. (canceled)

16. The method according to claim 3, wherein after the displaying the object received by the target user in the object display region of the personal homepage, the method further comprises:
cancelling the display of the object, in response to a third trigger operation acting on the personal homepage.

17. The method according to claim 4, wherein after the displaying the object received by the target user in the object display region of the personal homepage, the method further comprises:
cancelling the display of the object, in response to a third trigger operation acting on the personal homepage.

18. The method according to claim 3, further comprising:
displaying a target object corresponding to an object sending request in the object display region of the personal homepage and/or on the object display page, in response to the object sending request.

19. The method according to claim 4, further comprising:
displaying a target object corresponding to an object sending request in the object display region of the personal homepage and/or on the object display page, in response to the object sending request.

20. The method according to claim 5, further comprising:
displaying a target object corresponding to an object sending request in at least one of the object display region of the personal homepage and the object display page, in response to the object sending request.

21. The method according to claim 3, wherein the displaying the object received by the target user, comprises:
controlling the object received by the target user to move according to a preset control factor in response to preset conditions being met, wherein the preset control factor comprises at least one selected from a group consisting of a current tilt angle of a terminal device, gravity of the terminal device, and a preset elasticity coefficient of the object.

22. The method according to claim 4, wherein the displaying the object received by the target user, comprises:
controlling the object received by the target user to move according to a preset control factor in response to preset conditions being met, wherein the preset control factor comprises at least one selected from a group consisting of a current tilt angle of a terminal device, gravity of the terminal device, and a preset elasticity coefficient of the object.
